(19) United States
(12) Patent Application Publication
(10) Pub. No.: US 2011/0300294 A1
(43) Pub. Date: Dec. 8, 2011

(54) WRITABLE-ERASABLE SURFACES

(75) Inventors: Frank C. Nachtman, West Bloomfield, MI (US); Kevin Biller, Columbus, OH (US); John Goscha, Boston, MA (US)

(73) Assignee: IdeaPaint, Inc., Cambridge, MA (US)

(21) Appl. No.: 13/101,832

(22) Filed: May 5, 2011

Related U.S. Application Data
(60) Provisional application No. 61/331,501, filed on May 5, 2010.

(51) Int. Cl. B05D 3/02; B05D 3/06; C09D 175/06; B05D 5/00

(52) U.S. Cl. 427/189; 427/532; 524/539

(57) ABSTRACT

Writable-erasable surfaces prepared by a powder coating process are provided. The coatings have many desirable attributes. For example, the coatings (e.g., powder compositions) cure rapidly at elevated temperatures or under radiation, have low VOC emissions, and have reduced tendency to form ghost images, even after prolonged and repeated normal use.

### RELATED REFERENCES

This application claims priority to U.S. provisional patent application Ser. No. 61/331,501, filed May 5, 2010, the entire contents of which are herein incorporated by reference.

### TECHNICAL FIELD

This disclosure relates to writable-erasable surfaces prepared by a powder coating process, products that include such surfaces, and to the methods of making and using the same.

### BACKGROUND

Writable-erasable products typically include a substrate, such as paper, metal, or board, and a coating, such as a lacquer coating, extending upon the substrate. The coating provides a writing surface that can be marked using dry erase marking pens. Dry erase marking pens, which are typically felt tip marking instruments, contain inks that not only can mark such surfaces, but also can be erased with minimal effort using, e.g., a dry-eraser, cloth, or paper tissue. Such writable-erasable products can be used as whiteboards for presentation of information, e.g., in classrooms. The coatings can be applied to other products, such as metal furniture or cabinets which in turn can be creatively utilized as writing surfaces.

The erasability of dry erase inks from the writing surfaces of writable-erasable products can deteriorate over time, resulting in the formation of non-removable “ghost images.” In addition, such surfaces can be incompatible with some dry erase markers, and can be permanently marked if inadvertently written on with a permanent marker.

### SUMMARY

This disclosure relates to write-erasable surface coatings, products that include such coatings (e.g., whiteboards, metal furniture), and methods of making and using the same. Generally, provided coatings (i.e., coatings that have writable-erasable surfaces) are produced from one or more precursor materials in a powder form; the precursor materials cure upon exposure to elevated temperatures or radiation, so that the coating is produced. When the writing surface is marked with a marking material, the marking material can be erased to be effectively invisible (e.g., substantially invisible) with little or no ghosting, even after prolonged and repeated use. The one or more precursor materials that form the coatings emit minimal volatile organic compounds (VOCs) after curing on the substrate. Provided coatings have many desirable attributes, including one or more of the following: low porosity, low surface roughness, high elongation at break, high Taber abrasion resistance, and high Sward hardness. Generally, while not intending to be bound by any theory, it is believed that low porosity of provided coatings makes such coatings substantially impervious to the marking materials, while low surface roughness prevents the marking materials from becoming entrapped on the surface beyond effective reach of an eraser.

In one aspect of the disclosure, a writable-erasable product can include a cured (such as cross-linked) coating extending upon a substrate and having a writable-erasable surface. The curing can occur upon exposure to an elevated temperature (such as from about 40° C. to about 200° C.), a radiation or a combination thereof. The coating can be formed from a material in a powder form. After the writable-erasable surface is marked with a marking material including a colorant and a solvent, the marking material can be erased from the writable-erasable surface to be effectively (e.g., substantially) invisible.

In some implementations, the solvent can include one or more of water, alcohols, ketones, esters, mineral spirits, and bio-based solvents.

In some implementations, the radiation can be ultra-violet radiation, electron-beam radiation, infrared radiation, mid infrared radiation, near infrared radiation or a combination thereof.

In some implementations, the cured coating and/or the writable-erasable surface may have one or more of the following attributes. The coating may have a porosity of less than about 40 percent; a thickness of from about 0.001 inch to about 0.125 inch; a Taber abrasion value of from about 100 to about 125 mg/thousand cycles; a Sward hardness of greater than about 10; an elongation at break of between about 5 percent and about 400 percent. The writable-erasable surface can be erased to be substantially invisible after writing and erasing at the same position for more than about 100 cycles, or even more than about 5,000 cycles. The writable-erasable surface can have an average surface roughness (Rₐ) of less than about 7,500 nm; a maximum surface roughness (Rₘ) of less than about 10,000 nm; a contact angle of greater than about 35 degrees; a contact angle of less than about 150 degrees.

In some implementations, the material in the powder form can have a glass transition temperature of greater than about 40° C.

In some implementations, the material in the powder form has an average particle size of from 2 microns to about 100 microns.

In some implementations, the material in the powder form can include a resin and optionally can include a curing agent, a pigment, or an additive.

In some implementations, the resin can be a polyurethane resin, a epoxy resin, a polyester resin, a polyamide resin, an alkyd resin, a polyvinyl resin, a polyolefin resin, an acrylic resin, or mixtures thereof as described herein.

In some implementations, the substrate can be selected from the group consisting of cellulosic material, glass, wall (such as plaster or painted), fiber board (e.g., a whiteboard in which the cured coating can be extending upon a fiber board), particle board (e.g., a chalkboard or blackboard), gypsum board, wood, plastics (such as high density polyethylene (HDPE), low density polyethylene (LDPE), or polyacrylonitrile, butadiene, styrene (ABS)-based material), densified ceramics, stone (such as granite), and metal (such as aluminum or stainless steel).

In some implementations, the substrate can be selected from a flexible film or a rigid immovable structure.

In some implementations, the marking material can be erased from the writable-erasable surface to be effectively invisible by wiping the marks with an eraser including a fibrous material (such as a paper towel, rag, or felt material).

In some implementations, the eraser can be dry or can include water, alcohol (e.g., ethanol, n-propanol, isopropanol, n-butanol, isobutanol, benzyl alcohol), alkoxy alcohol (e.g., 2-(n-propoxy) ethanol, 2-(n-butoxy) ethanol, 3-(n-propoxy) ethanol), ketone (e.g., acetone, methyl ethyl ketone, methyl n-butyl ketone), ketonic alcohol (e.g., diacetone alcohol), ester (e.g., methyl succinate, methyl benzoate, ethyl propanoate), acetate (e.g., methyl acetate, ethyl acetate, n-butyl acetate, t-butyl acetate), mineral spirit, or mixtures thereof.

In some implementations, the writable-erasable product can take the form of a whiteboard, in which the cured coating extends upon a fiberboard; can form a part of a wall e.g., of a structure; or can form a plurality of sheets, each sheet including a substrate (e.g., in the form of a paper) having the cured coating extending thereupon.

In another aspect, the disclosure describes a method of changeably presenting information including marking the writable-erasable surface with a first information using a marking material. After the surface has been marked with the marking material; erasing the marking of the first information (e.g., by applying an eraser to the writable-erasable surface) from the writable-erasable surface to be effectively invisible. This can be followed by marking the writable-erasable surface with a second information and again erasing the marking of the second information from the writable-erasable surface to be effectively (e.g., substantially) invisible.

In some implementations, the coating can be formed from one or more materials in a powder form.

In some implementations, the marking material can include a colorant and a solvent (e.g., water, alcohol, alkoxy alcohol, ketone, ketonic alcohol, ester, acetate, mineral spirit, bio-based solvents, or their mixtures).

In some implementations, the marking and erasing of second information can be performed repeatedly.

In some implementations, the erasing can be performed by applying an eraser (such as including a fibrous material) to the writable-erasable surface.

In some implementations, the eraser can include water, alcohol, alkoxy alcohol, ketone, ketonic alcohol, ester, acetate, mineral spirit, or their mixtures.

In another aspect, the disclosure describes a method of making a writable-erasable product, the method including, applying (e.g., spraying) a material in a powder form onto a substrate to form a coating extending upon the substrate and exposing the coating to an elevated temperature or radiation to provide a cured coating defining a writable-erasable surface. After the writable-erasable surface is marked with a marking material including a colorant and a solvent, the marking material can be erased from the writable-erasable surface to be effectively (e.g., substantially) invisible.

In some implementations, the spraying can be performed by fluidized bed technique, electrostatic spraying, or flame-spraying.

In some implementations, the elevated temperature can be from about 40° C. to about 200° C.

In some implementations, the radiation can be ultra-violet radiation, electron-beam radiation, infrared radiation, mid infrared radiation, near infrared radiation or a combination thereof.

Implementations and/or aspects may include one or more of the following advantages. The coating surfaces are writable and erasable. The coatings can provide writing surfaces that exhibit little or no image ghosting, even after prolonged and repeated normal use. The coatings can be simple to prepare, and can be applied to many different substrates, including both porous (e.g., paper) and non-porous substrates (e.g., ceramics, metal). The coatings can be applied to various substrates including, but not limited to, metal furniture, chalkboards (e.g., blackboards), whiteboards, drywalls, gypsum boards, plaster and painted walls. The coatings can be applied on the substrate on-site or manufactured in a factory. For many substrates, a single application of coating can provide an adequate writable-erasable surface. The coatings can exhibit good adhesive strength to many substrates. Coating components (e.g., precursor materials prior to mixing and/or coating compositions prior to curing) can have an extended shelf-life, e.g., up to about three years or even up to six years. The coatings can be readily resurfaced. The coatings can cure rapidly, e.g., in less than 2 hours. The coatings can resist yellowing, as determined by ASTM method G-154, for an extended period of time (e.g., up to 2000 hours or even up to 5000 hours). The coatings can have a reduced tendency to run, even when applied upon a vertical substrate. Surface gloss of the coatings can be readily adjusted. The writing surface of the coating can be used as a projectable screen (e.g., for a projector). The coatings can be hard. The coatings can be substantially impervious to organic solvents and/or inks. The coatings can have a low porosity. Surfaces of the coatings can have a low roughness. The coatings can be impact resistant. The coatings can be made scratch and abrasion resistant. The coatings can be relatively low cost. The coatings can have a high chemical resistance.

As used herein, “elevated temperature” refers to a temperature above ambient temperature. For example, an elevated temperature can be at least about 40° C.

“Curing” as used herein, refers to a process of setting (e.g., by evaporation or cross-linking) a material to form a cured coating on a substrate. Curing can be performed by heating, exposing to radiation, or cross-linking (e.g., oxidative cross-linking). As will be understood by those of skill in the art, curing processes may involve formation and/or destruction of one or more chemical bonds (e.g., as in cross-linking).

“Degassing additive” as used herein, refers to an agent used to accelerate the shrinkage of air bubbles trapped within a coating during the curing process. Inclusion of a degassing additive accelerates bubble shrinkage such that they are released prior to substantial thickening or viscosity increase of the coating.

“Effectively invisible” as used herein, refers to a color difference Delta E (−E) of less than 100 as calculated according to the ASTM Test Method D2244 before and after a mark is erased by an eraser.

“Flow control additive” as used herein, refers to a material which acts to reduce the flow index of a coating in order to provide a uniform film thickness and minimize surface imperfections.

“Substantially invisible” as used herein, refers to a color difference Delta E (−E) of less than 10 as calculated according to the ASTM Test Method D2244 before and after a mark is erased by an eraser.

“Alkyl” as used herein, refers to a saturated or unsaturated hydrocarbon containing 1-20 carbon atoms including both acyclic and cyclic structures (such as methyl, ethyl, propyl, isopropyl, butyl, iso-butyl, sec-butyl, pentyl, hexyl, cyclopropyl, cyclobutyl, cyclopentyl, cyclohexyl, propenyl, butenyl, cyclohexenyl and the like). A linking divalent alkyl group is referred to as an “alkylene” (such as ethylene, propylene and the like).

As used herein, “aryl” refers to monocyclic or polycyclic (e.g., having 2, 3 or 4 fused rings) aromatic hydrocarbons such as, phenyl, naphthyl, anthracenyl, phenanthrenyl, indanyl, indenyl, and the like. In some embodiments, aryl groups have from 6 to about 20 carbon atoms, from 6 to about 15 carbon atoms, or from 6 to about 10 carbon atoms.

As used herein, “heteroaryl” refers to an aromatic heterocycle having at least one heteroatom ring atom such as sulfur, oxygen, or nitrogen. Heteroaryl groups include monocyclic and polycyclic (e.g., having 2, 3 or 4 fused rings) systems. Examples of heteroaryl groups include without limitation, pyridyl, furyl, quinolyl, indolyl, oxazolyl, triazolyl, tetrazolyl, and the like. In some embodiments, the heteroaryl group has from 1 to 20 carbon atoms (e.g., from 3 to 20 carbon atoms). In some embodiments, the heteroaryl group has 1 to 4 (e.g., 1 to 3 or 1 to 2 heteroatoms).

As used herein, “aralkyl” refers to alkyl substituted by aryl. An example aralkyl group is benzyl.

As used herein, “alkoxy” refers to an —O-alkyl group. Example alkoxy groups include methoxy, ethoxy, propoxy (e.g., n-propoxy and isopropoxy), t-butoxy, and the like.

As used herein, “oxyalkylene” refers to an —O-alkylene group.

As used herein, “alkoxylate” refers to an alkyl-C(O)O. Example alkoxylates include acetate, stearate and the like.

A “polyol” as used herein is a moiety that includes at least two hydroxyl (—OH) groups. The hydroxyl groups can be terminal and/or non-terminal. The hydroxyl groups can be primary hydroxyl groups.

A “polyurethane” as used herein is a polymeric or oligomeric material that includes a urethane linkage, [NHC(═O)O], in its backbone.

All publications, patent applications, patents, and other references mentioned herein are hereby incorporated by reference herein in their entirety.

The details of one or more implementations of the disclosure are set forth in the accompanying drawings, and in the description below. Other features, and advantages will be apparent from the description and drawings, and from the claims.

### BRIEF DESCRIPTION OF THE DRAWING

FIG. 1 is a top view of a writable-erasable product.

FIG. 1A is a cross-sectional view of the writable-erasable product of FIG. 1, taken along 1A-1A.

FIG. 2 is a cross-sectional view of a droplet of water on a coating and illustrates a method for determining contact angle.

FIG. 3 is a perspective view of a coated roll of paper.

FIG. 4 is a perspective view of a tablet of coated papers formed from the roll of FIG. 3.

Like reference symbols in various drawings indicate like elements.

### DETAILED DESCRIPTION

### Writable-Erasable Product:

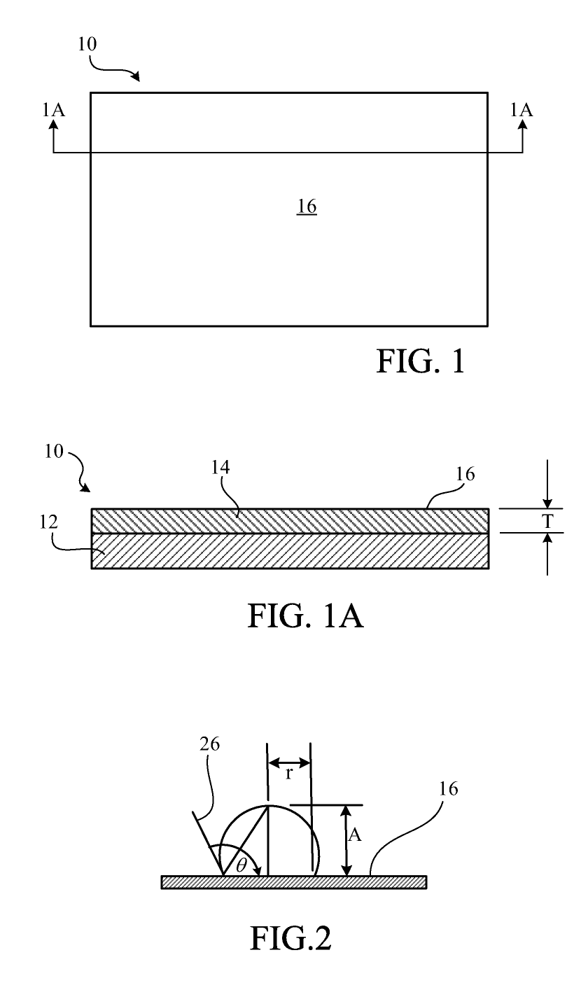

Referring to FIGS. 1 and 1A, a writable-erasable product 10 includes a substrate 12 and a coating 14 (e.g., a cured coating) extending upon the substrate 12. The coating 14 has a writable-erasable surface 16. When the writable-erasable surface 16 is marked with a marking material, the marking material can be erased from the writable-erasable surface to be effectively (e.g., substantially) invisible, resulting in little or no ghosting, even after prolonged normal use, for example, after about 10 cycles (e.g., after about 50 cycles, after about 100 cycles, after about 500 cycles, after about 1,000 cycles, after about 2,000 cycles, after about 3,000 cycles, after about 4,000 cycles, after about 5,000 cycles, after about 6,000 cycles, after about 7,000 cycles, after about 8,000 cycles, or after about 9,000 cycles) of writing and erasing at the same position. The visibility, or the lack thereof, of the erasing can be determined by measuring the color change (Delta E, ΔE) on the writable-erasable surface 16 using a spectrophotometer (such as the SP-62 portable spectrophotometer available from X-Rite), after marking on the surface and erasing the marking. The marking material can include a colorant (e.g., a pigment) and a solvent such as water, alcohol, ketone, ester, mineral spirit, bio-based solvents (e.g., vegetable oil, corn oil, sunflower oil), or mixtures thereof. The marking material can be selected from any of the industry standard dry-erase markers.

Any of a variety of different types of substrates can be utilized, including porous (e.g., paper) and non-porous substrates (e.g., ceramics, metals). The substrate 12 can be a flexible or a rigid structure. Examples of useful substrates or substrate materials include, but are not limited to, a polymeric material (such as a polyester or a polyamide), a cellulosic material (such as paper), glass, wood, plastics (such as HDPE, LDPE, or an ABS-based material), a wall (such as a plaster or painted wall), a fiber board (such as a whiteboard in which the cured coating extends upon a fiber board, medium-density fiberboard), a particle board, (such as a chalkboard or blackboard), a gypsum board, densified ceramics, stone (such as granite), and a metal (such as aluminum, aluminum alloys, zinc-plated surfaces, steel, galvanized steel, cold rolled steel, or stainless steel). The substrate could be a newly built structure or even an old and worn out chalkboard, blackboard, whiteboard, or metal furniture.

In some instances, the surface of the substrate can be cleaned by sanding the surface (e.g., by sand blasting) and priming the surface prior to application of the coating material in the powder form. In some instances, the surface can also be cleaned with a cleaning agent (e.g., acetone or a mild acid) in order to provide better adhesion of the coating to the surface.

The materials that form the coating 14 (e.g., precursor materials) are in a powder form during a powder coating process and, upon application to a substrate, typically cure at an elevated temperature or through exposure to radiation. The curing can be performed by methods known in the art, such as evaporation or cross-linking (e.g., oxidative cross-linking or using a cross-linking agent) among the materials that form the coating. Cross-linking between polymeric chains can influence certain unique properties of coatings. In some implementations, the material in the powder form can cure at a temperature of at least about 40° C., e.g., at least about 50° C., at least about 70° C., at least about 90° C., at least about 110° C., at least about 130° C., at least about 150° C., at least about 170° C., or at least about 200° C. In some implementations, the material in the powder form can cure at a temperature of from about 40° C. to about 200° C., e.g., from about 60° C. to about 180° C., from about 80° C. to about 160° C., from about 100° C. to about 140° C., from about 60° C. to about 100° C., or from about 80° C. to about 100° C. Typically, low-bake curing involves heating the substrate with the powdered material below 160° C. In some implementations, the curing could be performed by radiation such as, ultra-violet radiation, infrared radiation (such as near infrared, mid infrared, or far infrared radiation), or electron-beam radiation. The ultra-violet (UV) radiation for curing can have a wavelength of from about 100 nm to about 400 nm. In some implementations, the UV radiation can have a wavelength at least about 100 nm, e.g., at least about 150 nm, at least about 200 nm, at least about 250 nm, at least about 300 nm, at least about 350 nm, or at least about 400 nm. The infrared (IR) radiation typically have a wavelength in the range of from about 0.76 microns to about 1000 microns. In some implementations, the IR radiation can have a wavelength of at least about 2 microns, e.g., at least about 2.4 microns, at least about 2.8 microns, at least about 3.2 microns, or at least about 3.6 microns. The electron-beam radiation can have energies from about 125 keV (kilo electron volt) to about 2.5 MeV (million electron volt) and can have more than about 1,000 fold stronger than the UV-light. Generally, while not intending to be bound by any theory, it is believed that the electron-beam radiation can be used with materials that contain opaque pigments and in applications that require higher coating thickness. In some implementations, the curing can performed by using two or more of the methods described above (e.g., by both heating at an elevated temperature and radiation). The coating 14 can be cured in at least about 2 minutes, e.g., at least about 5 minutes, at least about 10 minutes, at least about 20 minutes, at least about 30 minutes, at least about 40 minutes, at least about 50 minutes, at least about 60 minutes, or at least about 120 minutes.

The porosity of a coating (e.g., a cured coating) can determine the amount of marking material that can be trapped in the coating. Lower porosity of coatings can lead to better writable-erasable surfaces. In some implementations, the coating 14 can have a porosity of between about 1 percent and about 40 percent, e.g., between about 2 percent and about 35 percent, between about 2.5 percent and about 30 percent, or between about 3 percent and about 20 percent. In other implementations, the coating 14 can have a porosity of less than about 40 percent, e.g., less than about 35 percent, less than about 30 percent, less than about 25 percent, less than about 20 percent, less than about 15 percent, less than about 10 percent, less than about 5 percent, or even less than about 2.5 percent. In some specific implementations, the coating 14 can have a porosity of about 3 percent, about 33 percent or about 34 percent.

The coating 14 can be applied in a single coat or multiple coats using any of the methods described herein. In some implementations, it can be painted using a spray gun in a single coat. In some implementations, the coating 14 (e.g., the cured coating) can have a dry film thickness, T (FIG. 1A), e.g., between about 0.001 inch and about 0.125 inch, e.g., between about 0.002 inch and about 0.1 inch, or between about 0.004 inch and about 0.08 inch, or between about 0.006 inch and about 0.06 inch, or between about 0.008 inch and about 0.04 inch, or between about 0.01 inch and about 0.02 inch. In other implementations, the coating 14 can have a thickness of greater than about 0.005 inch, e.g., greater than about 0.0075 inch, greater than about 0.010, or greater than about 0.020 inch. While not intending to be bound by any theory, it is believed that providing an uniform, adequate coating thickness, T, reduces the likelihood of thin or uncoated substrate portions where marking material might penetrate. The typical DFT (dry film thickness) range of coatings utilizing conventional electrostatic spray techniques can be from about 0.001 inch to about 0.008 inch. Film thicknesses of from about 0.01 inch to about 0.02 inch can be achieved by using fluidized bed techniques.

In some implementations, the coating 14 (e.g., the cured coating) can have a Taber abrasion value of less than about 150 mg/thousand cycles, e.g., less than about 100 mg/thousand cycles, less than about 75 mg/thousand cycles, less than about 50 mg/thousand cycles, less than about 35 mg/thousand cycles, less than about 25 mg/thousand cycles, less than about 15 mg/thousand cycles, less than about 10 mg/thousand cycles, less than about 5 mg/thousand cycles, less than about 2.5 mg/thousand cycles, less than about 1 mg/thousand cycles, or even less than about 0.5 mg/thousand cycles. Maintaining a low Taber abrasion value can provide long-lasting durability to the coating, reducing the incidence of thin spots, which could allow penetration of marking material through the coating and into the substrate.

In some implementations, the coating 14 (e.g., the cured coating) can have a Sward hardness of greater than about 10, e.g., greater than about 15, greater than about 25, greater than about 50, greater than about 75, greater than about 100, greater than about 120, greater than about 150, or even greater than about 200. While not intending to be bound by theory, it is believed that maintaining a high Sward hardness provides long-lasting durability and scratch resistance to the coating. Marking material entrapped in scratches can be difficult to erase.

In some specific implementations, the coating 14 (e.g., the cured coating) can have a Sward hardness of between about 10 and about 75, e.g., between about 15 and about 70 or between about 15 and about 55. In some specific implementations, the coating can have a Sward hardness of about 15, about 22 or about 25.

In some implementations, elongation at break for the coating material (e.g., the cured coating material) can be between about 5 percent and about 400 percent, e.g., between about 25 percent and about 200 percent, or between about 50 percent and about 150 percent. In other implementations, the elongation at break can be greater than about 10 percent, e.g., greater than about 25 percent, greater than about 50 percent, or even greater than about 100 percent. While not intending to be bound by theory, it is believed that maintaining high elongation at break provides long-lasting durability to the coating, and it allows the coating to be stressed without forming cracks. Cracks can trap marking materials, making erasure from surfaces difficult and hence decreasing the longevity of the writable-erasable products.

In some implementations, the average particle size for the coating material in the powder form (e.g., for the powder of precursor materials and optionally other agents) can be from about 1 micron to about 200 microns, e.g., from about 2 microns to about 10 microns, from about 10 microns to about 50 microns, from about 50 microns to about 100 microns, or from about 100 microns to about 200 microns. In some implementations, the average particle size for the coating material in the powder form can be from about 20 microns to about 50 microns, e.g., from about 20 microns to about 25 microns, from about 25 microns to about 30 microns, from about 30 microns to about 35 microns, from about 35 microns to about 40 microns, or from about 40 microns to about 50 microns. In some embodiments, the average particle size for the coating material in the powder form can be about 1 micron, about 2 microns, about 10 microns, about 15 microns, about 20 microns, about 25 microns, about 30 microns, about 40 microns, about 50 microns, about 60 microns, about 70 microns, about 100 microns, or about 200 microns. In some embodiments, the average particle size for the coating material in the powder form can be in a range between a lower value and an upper value. In some embodiments, the lower value is selected from the group consisting of 1 micron, 2 micron, 5 microns, 10 microns, 15 micron, 20 microns, 25 microns, 30 microns, 35 microns, 40 microns, 45 microns, 50 microns, 60 microns, 70 microns, 80 microns, 90 microns, 100 microns, or more. In some embodiments, the upper value is selected from the group consisting of 200 microns, 100 microns, 90 microns, 80 microns, 70 microns, 60 microns, 50 microns, 45 microns, 40 microns, 35 microns, 30 microns, 25 microns, 20 microns, 15 microns, 10 microns, 5 microns, and 2 microns, and the range is any combination of these lower and upper values wherein the upper value is higher than the lower value.

In some implementations, the glass transition temperature (T_{g}) for the coating material in the powder form (e.g., for the powder of precursor materials and optionally other agents) can be at least about 10° C., e.g., at least about 15° C., at least about 20° C., at least about 25° C., at least about 40° C., at least about 50° C., at least about 70° C., at least about 90° C., at least about 110° C., at least about 130° C., at least about 150° C., at least about 170° C., or at least about 200° C. In some embodiments, the glass transition temperature (T_{g}) for the coating material in the powder form (e.g., for the powder of precursor materials and optionally other agents) can be in a range between a lower value and an upper value. In some embodiments, the lower value is selected from the group consisting of 10° C., 15° C., 20° C., 25° C., 30° C., 35° C., 40° C., 50° C., 60° C., 70° C., 80° C., 90° C., 100° C., 150° C., 170° C., or more. In some embodiments, the upper value is selected from the group consisting of 200° C., 170° C., 150° C., 100° C., 90° C., 80° C., 70° C., 60° C., 50° C., 40° C., 35° C., 30° C., 35° C., 30° C., 25° C., 20° C., and 15° C., and the range is any combination of these lower and upper values wherein the upper value is higher than the lower value. The T_{g} is typically determined by differential scanning calorimetry (DSC).

The pill flow rate of a powder material can be determined by measuring powder flow-out when heated. Pressed pellets, or “pills”, of a powder material can be placed on a preheated glass plate or panel and allowed to flow and gel. Flow distances can then be measured in millimeters (mm). For example, decorative coatings pill flow rates measure about 30-80 mm, which indicates a relative smoothness of the cured film. In general, the higher the pill flow, the smoother the cured film. In some implementations, the pill flow rate for a coating material in a powder form (e.g., for the powder of precursor materials and optionally other agents) can be from about 10 mm to about 100 mm, e.g., from about 10 mm to about 20 mm, from about 20 mm to about 30 mm, from about 30 mm to about 40 mm, from about 40 mm to about 50 mm, from about 50 mm to about 60 mm, from about 60 mm to about 70 mm, from about 70 mm to about 80 mm, from about 80 mm to about 90 mm, or from about 90 mm to about 100 mm.

In some implementations, the writable-erasable surface 16 can have an average surface roughness (Rₐ) of between about 0.5 nm and about 7,500 nm, e.g., between about 1 nm and about 6,000 nm, between about 2 nm and about 5,000 nm, between about 5 nm and about 2,500 nm, between about 10 nm and about 1,500 nm, between about 20 nm and about 1,000 nm or between about 25 nm and about 750 nm. In other implementations, the writable-erasable surface 16 can have an average surface roughness (Rₐ) of less than about 7,500 nm, e.g., less than about 5,000 nm, less than about 3,000 nm, less than about 2,000 nm, less than about 1,000 nm, less than about 500 nm, less than about 250 nm, less than about 200 nm, less than about 100 nm, or even less than about 50 nm. In some specific implementations, the writable-erasable surface 16 can have an average surface roughness (Rₐ) of about 150 nm, about 300 nm or about 1,000 nm.

In some implementations, the writable-erasable surface 16 can have a maximum surface roughness (Rₘ) of less than about 10,000 nm, e.g., less than about 8,000 nm, less than about 6,500 nm, less than about 5,000 nm, less than about 3,500 nm, less than about 2,000 nm, less than about 1,000 nm, or less even than about 500 nm.

In some implementations, the writable-erasable surface 16 can have a flat finish (gloss below 15, measured at 85 degrees), an eggshell finish (gloss between about 5 and about 20, measured at 60 degrees), a satin finish (gloss between about 15 and about 35, measured at 60 degrees), a semi-gloss finish (gloss between about 30 and about 65, measured at 60 degrees), or gloss finish (gloss greater than about 65, measured at 60 degrees).

In some specific implementations, the writable-erasable surface 16 can have a 60 degree gloss of between about 45 and about 90, e.g., between about 50 and about 85. In other implementations, the writable-erasable surface 16 can have a 20 degree gloss of between about 10 and about 50, e.g., between about 20 and about 45. In still other implementations, the writable-erasable surface 16 can have a 85 degree gloss of between about 45 and about 90, e.g., between about 75 and about 90. In other specific implementations, the writable-erasable surface 16 can have a 20 degree gloss of about 12, about 23, or about 46; or a 60 degree gloss of about 52, about 66, or about 85; or a 85 degree gloss of about 64, about 78, or about 88.

In some implementations, to improve the writability and erasability of the surface 16 of the coating 14, precursor materials can be chosen so that the cured coating has a surface that is relatively hydrophilic and not very hydrophobic. Referring to FIG. 2, hydrophobicity of the writable-erasable surface 16 is related to its wetability by a liquid, e.g., a water-based marking material. It is often desirable to quantify the hydrophobicity of the writable-erasable surface 16 by a contact angle. Generally, as described in ASTM D 5946-04, to measure contact angle, θ, for a liquid (such as water) on the writable-erasable surface 16, an angle is measured between the writable-erasable surface 16 and a tangent line 26 drawn to a droplet surface of the liquid at a three-phase point. Mathematically, θ is 2×arctan(A/r), where A is the height of the droplet image, and r is half width at the base. In some implementations, it can be desirable for the writable-erasable surface 16 to have a contact angle, θ, measured using deionized water, of less than about 150 degrees, e.g., less than about 125 degrees, less than about 100 degrees, less than about 75 degrees, less than about 50 degrees or even less than about 40 degrees. In other implementations, it can be desirable for the writable-erasable surface 16 to have a contact angle θ above about 35 degrees, e.g., above about 40 degrees, or above about 45 degrees.

In certain implementations, contact angle, θ, measured using deionized water, can be between about 30 degrees and about 90 degrees, e.g., between about 45 degrees and about 80 degrees, or between about 39 degrees and about 77 degrees. In some specific implementations, the contact angle can be about 40 degrees, about 50 degrees, about 60 degrees, about 73 degrees, or about 77 degrees.

In some implementations, the marking material used on the writable-erasable surface 16 can have a surface tension of between about 20 dynes/cm and about 60 dynes/cm, e.g., between about 30 dynes/cm and about 50 dynes/cm. In some specific implementations, the marking material used on the writable-erasable surface 16 can have a surface tension of about 25 dynes/cm, about 30 dynes/cm, about 35 dynes/cm, about 42 dynes/cm, about 44 dynes/cm, or about 56 dynes/cm.

Advantageously, when the writable-erasable surface 16 is marked with a marking material that includes a colorant and a solvent, the marking material can be erased from the writable-erasable surface 16 to be effectively (e.g., substantially) invisible. The solvent can include one or more of water, alcohols, alkoxy alcohols, ketones, ketonic alcohols, esters, acetates, mineral spirits, or bio-based solvents (e.g., vegetable oil, corn oil, or sunflower oil). Mixtures of any of the noted solvents can also be used. For example, mixtures of two, three, four or more of the noted solvents may be used.

In some implementations, the marking material can be erased from the writable-erasable surface 16 to be effectively (e.g., substantially) invisible by wiping a mark with an eraser that includes a fibrous material. For example, the eraser can be in the form of a disposable wipe, a cloth, or a supported (e.g., wood, plastic) felt. The eraser can also include a solvent such as water, alcohols (e.g., alkoxy alcohols, ketonic alcohols), ketones, esters (e.g., acetates), or mineral spirits. Mixtures of any two or more of these solvents may also be used.

Examples of alcohols that can be used in the marking material or the eraser include ethanol, n-propanol, iso-propanol, n-butanol, iso-butanol, benzyl alcohol, 2-(n-propoxy) ethanol, 2-(n-butoxy) ethanol and 3-(n-propoxy) ethanol.

Examples of ketones that can be used in the marking material or the eraser include acetone, methyl ethyl ketone and methyl n-butyl ketone.

Examples of esters that can be used in the marking material or the eraser include methyl acetate, ethyl acetate, n-butyl acetate and t-butyl acetate.

For testing, the cured coating 14 can be made by casting a powder material on a panel substrate similar to the desired end product, and then curing the material so that it can have a preferred dry thickness. The cured sample can then provide the test specimen. Testing can be performed at 25° C. Elongation at break can be performed using ASTM method D-882; porosity can be measured using mercury porosimetry (suitable instruments available from Micromeritics, Norcross, Ga., e.g., Micromeritics Autopore IV 9500); surface roughness can be measured using atomic force microscopy (AFM) in tapping mode using ASME B46.1 (suitable instruments, e.g., WYKO NT8000, are available from Park Scientific); Taber abrasion resistance can be measured according to ASTM method D-4060 (wheel CS-17, 1 kg load) and Sward hardness can be measured according to ASTM method D-2134 (Sward Hardness Rocker Model C). Gloss can be measured using ASTM method D-523-89 (BYK Tri-Gloss Meter Cat. No. 4525). Contact angle can be measured with deionized water using the dynamic contact angle method (Angstroms Model FTA 200) using ASTM method D-5946-04. Surface tension can be measured using AccuDyne Marking Pens.

Any writable-erasable product described herein can have any one or more of any of the attributes described herein. For example, the writable-erasable surface 16 can have an average surface roughness (Rₐ) of less than about 7,500 nm, a maximum surface roughness (Rₘ) of less than about 7,500 nm, a 60 degree gloss of less than about 50 and a contact angle of less than about 100 degrees.

Any coatings (e.g., cured coatings) described herein can have any one or more of any of the following attributes. For example, the coating can have a porosity of less than about 45 percent, an elongation at break of between about 25 percent and about 200 percent, and/or a Sward hardness of greater than about 3 and a Taber abrasion value of less than about 150 mg/thousand cycles. The cured coating described herein can be generally stable and also emit little or no VOCs after curing.

### Formulations:

Powder coating processes utilize fine particles of a homogeneous mixture of components such as resins, curing agents, pigments, and other modifying agents to provide, upon curing, uniform coatings on desired surfaces. The use of powder coating processes can provide a high quality finish and in many applications, such coatings can be durable; can provide a larger thickness compared to coatings formed by a liquid-based method; can lead to a reduced carbon footprint of the marketed product as the unused powder can be recycled during the coating process. Particles used in a powder coating process can be formed, without limitation, from either thermoplastic or thermosetting resins. Depending on the type of polymeric resins used, it can be possible to obtain either a tough, impact resistant finish (such as with thermoplastic resins) or a decorative finish (such as with thermoset resins). The coating formulations, in general, can include the materials described below and can be packaged to be ready for use. The resin can be selected from polyurethane resins, epoxy resins, polyester resins, polyamide resins, alkyd resins, polyvinyl resins, polyolefin resins, or acrylic resins. The present invention encompasses the recognition that powder coating processes can desirably be utilized with compositions that form writable-erasable surfaces. That is, in one aspect, the present invention encompasses the recognition that certain materials that cure to form desirable writable-erasable surfaces are amenable to powder processing and/or coating methodologies, as described in more detail herein.

In general, provided powder compositions comprise at least one resin component and are characterized in that they cure, when exposed to curing conditions, to form a cured material with a writeable-erasable surface. In some embodiments, as will be appreciated by those of ordinary skill in the art reading the present disclosure, provided powder compositions further include one or more curing agents. In some embodiments, provided powder compositions include one or more pigments, for example so that the final cured material is not clear and has a specific color. In some embodiments, provided powder compositions include one or more other agents, for example that modify or contribute to one or more features of the powder, of its amenability to processing techniques, and/or of the ultimate applied or cured coating.

Polyurethane Resins

Polyurethanes can be obtained by the reaction of a diisocyanate or a polyisocyanate with a diol or a polyol. Polyurethanes exhibit a wide range of hardness and flexibility depending on the nature of the isocyanate and/or the polyol in addition to the nature of curing. Reactive polyurethane coatings involve the isocyanate as the reactive group during curing. See: The ICI Polyurethanes Book, George Woods. (John Wiley & Sons: New York, 1987), and Organic Coatings-Properties, Selection and Use U.S. Department of commerce, National Bureau of Standards: Washington D.C., Series 7; February 1968. Polyurethane coatings have also been categorically assigned several ASTM designations (Types I-V1).

Certain polyurethane materials can form writable-erasable coatings as described herein. The present invention provides compositions, and specifically provides powder compositions comprising polyurethane resin materials, which compositions cure to form writeable-erasable polyurethane coatings as described herein.

For example, the coating 14 described in FIG. 1 can be formed from one or more materials including one or more isocyanate (such as diisocyanante) and one or more materials including one or more hydroxyl. That is, in some embodiments, a coating 14 as depicted in FIG. 1 is formed from isocyanate (e.g., diisocyanate) and hydroxyl-containing (e.g., polyol, polyester) precursor materials. The present invention provides powder compositions comprising such precursor materials. In some implementations, provided compositions include those that, prior to or after application to a surface, can be or include a material (e.g., a polyurethane) that can be a reaction product of an isocyanate and a hydroxyl containing compound (such as a polyol).

Provided polyurethane resin materials may include one or more isocyanate materials. Such one or more isocyanate materials can be an isocyanate, blocked isocyanate, oligomers and homopolymers thereof, and any combination thereof.

In some embodiments, isocyanate materials include an isocyanate in a blocked form which the isocyanate can be released during the curing process. Examples of blocking agents include, but not limited to, caprolactam, epsilon-caprolactam, methyl-ethyl ketoxime, uretdione, and benzotriazole.

Diisocyanates for use in polyurethane applications, in general, can be obtained by the reaction of amines with phosgene. Examples of organic diisocyanates include aliphatic, cycloaliphatic (alicyclic), and aromatic diisocyanates. e.g., methylene diisocyanate, tetramethylene diisocyanate, hexamethylene diisocyanate (HDI), octamethylene diisocyanate, decamethylene diisocyanate, 2-methylpentane-1,5-diisocyanate, toluene diisocyanate (TDI), diphenylmethane diisocyanate (MDI), m- and p-phenylene diisocyanates, 4-chloro-m-phenylene diisocyanate, bitolylene diisocyanate, cyclohexane diisocyanate (CHDI), bis-(isocyanatomethyl)cyclohexane (H6XDI), dicyclohexylmethane diisocyanate (H12MDI), dimer acid diisocyanate (DDI), trimethyl hexamethylene diisocyanate, lysine diisocyanate and its methyl ester, methyl cyclohexane diisocyanate, 1,5-napthalene diisocyanate, xylene diisocyanate, polyphenylene diisocyanates, isophorone diisocyanate (IPDI), hydrogenated methylene diphenyl isocyanate (HMDI), tetramethyl xylene diisocyanate (TMXDI), 4-t-butyl-m-phenylenediisocyanate, 4,4′-methylene bis(phenyl isocyanate), tolylene diisocyanate, 4-methoxy-m-phenylene diisocyanate, biphenylene diisocyanate, cumene-2,4-diisocyanate, 3,3′-dimethyl-4,4′-biphenylene diisocyanate, p,p′-diphenylene diisocyanate, or oligomers and homopolymers thereof, and mixtures thereof.

Monomeric diisocyanates may be converted into oligomeric prepolymers of higher molecular weight by treatment with diols or triols. Such oligomeric prepolymers can also be used as a reaction component (e.g., precursor material) in the production of the polyurethane coating.

Diisocyanates for use in polyurethane applications can be available from various commercial vendors under different trade names. Examples of commercial isocyanates or polyurethanes include, but are not limited to, Alcure such as Alcure 4402 (available from Momentive); ADDITOL (available from Cytec); ALESTA® (available from Dupont); and URALAC® (available from DSM).

In some embodiments, an aliphatic isocyanate can be used in accordance with the present invention. In some embodiments, an aliphatic isocyanate having an isocyanate (NCO) equivalent weight about or more than 150 grams. In some embodiments, an aliphatic isocyanate having an isocyanate (NCO) equivalent weight about 200 grams. In some embodiments, an aliphatic isocyanate having an isocyanate (NCO) equivalent weight about 300 grams. In some embodiments, an aliphatic isocyanate having an isocyanate (NCO) equivalent weight about 150 grams, about 200 grams, about 210 grams, about 220 grams, about 230 grams, about 240 grams, about 250 grams, about 260 grams, about 270 grams, about 280 grams, about 290 grams, about 300 grams, about 310 grams, about 320 grams, about 330 grams, about 340 grams, or about 350 grams. In some embodiments, an aliphatic isocyanate having an isocyanate (NCO) equivalent weight in a range of any two values above.

In some embodiments, provided polyurethane resin materials, that cure to form writable-erasable polyurethane coatings, comprise one or more polyurethanes and/or one or more sets of an isocyanate material (e.g., a diisocyanate material) and a hydroxyl-containing material (e.g., a polyol material, polyester material) that together react to form a polyurethane material. The present invention therefore provides powders containing a “polyurethane resin” that in fact comprises an isocyanate material and a hydroxyl-containing material that will react (e.g., under curing conditions) to generate a polyurethane.

In some embodiments, provided coating materials (e.g., curable compositions such as powder compositions, applied coatings, and/or cured coatings) may comprise about or more than 30 wt % polyurethane. In some embodiments, provided coating materials may comprise about or more than 50 wt % polyurethane. In some embodiments, provided coating materials may comprise about or more than 60 wt % polyurethane. In some embodiments, provided coating materials may comprise about or more than 70 wt % polyurethane. In some embodiments, provided coating materials may comprise about 30 wt %, about 35 wt %, about 40 wt %, about 45 wt %, about 50 wt %, about 55 wt %, about 60 wt %, about 65 wt %, about 70 wt %, about 75 wt %, about 80 wt %, or about 90 wt % polyurethane. In some embodiments, provided coating materials may comprise polyurethane in a range between a lower value and an upper value. In some embodiments, the lower value is 30%. In some embodiments, the lower value is selected from the group consisting of 30%, 35%, 40%, 45%, 50%, 55%, 60%, 65%, 70%, 75%, 80%, 85%, 90%, 91%, 92%, 93%, 94%, 95%, or more. In some embodiments, the upper value is selected from the group consisting of 99%, 98%, 97%, 96%, 95%, 94%, 93%, 92%, 90%, 85%, 80%, 75%, 70%, 65%, 60%, 55%, 50%, 45%, 40%, 39%, 38%, 37%, 36%, 35%, 34%, 33%, 32%, 31%, or 30%, and the range is any combination of these lower and upper values wherein the upper value is higher than the lower value.

In some implementations, the percentage weight of isocyanate materials including an isocyanate, blocked isocyanate, or their oligomers and homopolymers thereof in the total material formulation (e.g., curable compositions such as powder compositions, and/or uncured coatings) can be from about 5% to about 95%, e.g., from about 5% to about 15%, from about 15% to about 25%, from about 25% to about 35%, from about 35% to about 45%, from about 45% to about 55%, from about 55% to about 65%, from about 65% to about 75%, from about 75% to about 85%, or even from about 85% to about 95%. In some implementations, the percentage weight of material including an isocyanate, blocked isocyanate, or their oligomers and homopolymers thereof in the total material formulation (e.g., curable compositions such as powder compositions, and/or uncured coatings) is greater than or equal to about 30%, for example, can be about 30%, 40%, 45%, 50%, 55%, 60%, 65%, 70%, or 75%. In some embodiments, the percentage weight of material including an isocyanate, blocked isocyanate, or their oligomers and homopolymers thereof in the total material formulation (e.g., curable compositions such as powder compositions, and/or uncured coatings) is in a range between a lower value and an upper value. In some embodiments, the lower value is about 30%. In some embodiments, the lower value is selected from the group consisting of 30%, 35%, 40%, 45%, 50%, 55%, 60%, 61%, 62%, 63%, 64%, 65%, 66%, 67%, 68%, 69%, 70%, 75% or more. In some embodiments, the upper value is selected from the group consisting of 80%, 75%, 70%, 65%, 60%, 55%, 50%, 45%, 40%, 39%, 38%, 37%, 36%, 35%, 34%, 33%, 32%, 31%, or 30%, and the range is any combination of these lower and upper values wherein the upper value is higher than the lower value.

Epoxy Resins

An epoxy coating formulation can be obtained by mixing an epoxy resin with a curing agent. The epoxy resins can include polyether chains that contain one or more epoxide units in their structure. Polyethers have the repeating oxyalkylene units: alkylene substituted by oxygen groups, e.g., ethyleneoxy, —[CH₂—CH₂O]—. In some implementations, the polyether chains can have additional functional groups such as hydroxyl (—OH). Curing of epoxy resins can lead to less amount of volatile products. Due to the unique properties of the epoxide ring structure, the curing agents can be either nucleophilic or electrophilic. Nucleophilic agents such as alcohols, phenols, amines, amino silanes, thiols, carboxylic acids, and acid anhydrides can be used. In some implementations, these curing agents can contain one or more nucleophilic groups. The epoxy resins themselves can contain an aliphatic (such as cyclic or acyclic) or an aromatic backbone or a combination of both. In some optional implementations, the epoxy resins can contain other non-interfering chemical linkages (such as alkyl chains).

For example, the coating 14 described in FIG. 1 can be formed from an epoxy material and an hydroxyl or an amine material. In some implementations, the material can be or includes a reaction product of an epoxide or oxirane material (such as an epoxy prepolymer) and an alcohol, an alkyl amine (such as a cyclic or acyclic alkyl amine), a polyol, a polyamine (such as isophoronediamine), a polyester polyamine, or an amido polyamine. In such implementations, the epoxide or oxirane material can serve as a cross-linking material. In some implementations, an oxazolidine can be added to serve as an accelerator. In some specific implementations, the epoxide material can be epichlorohydrin, glycidyl ether type (such as diglycidyl ether of bisphenol-A), oxirane modified fatty acid ester type, or oxirane modified ester type. In some specific implementations, the polyol material can be a polyester polyol, polyamine polyol, polyamide polyol, or amine adduct polyol.

Polyamide Resins

Polyamide resins have the repeating units which are linked by the functional group —C(O)NH—. Polyamide resins can be used as thermoplastic or thermoset powder coatings, and as hybrid coatings such as epoxy-polyamide hybrid powder.

Polyester Resins

Polyester resins have the repeating units which are linked by the functional group —COO—. Polyester resins can be used as thermoplastic or thermoset powder coating, and as hybrid coatings: epoxy-polyester hybrid powder, urethane-polyester powder, and polyester-triglycidyl isocyanurate (TGIC) powder. Polyester resins can either be hydroxy functional, which can be cured with isocyanates, or carboxy functional which can be cured with epoxies or beta-hydroxy alkyl amides (Primid®) to provide hybrid systems. Examples of commercial polyesters include, but are not limited to, FINE-CLAD (available from Reichhold Chemicals); CRYLCOAT (available from Cytec), and CURALITE® (available from Perstorp).

Alkyd Resins

Alkyd resins are thermoset resins which are complex polyesters formed by the condensation of polyhydric alcohols (such as glycerol) with polybasic acids (such as malonic or succinic acid).

Acrylic Resins

Polyacrylates (also known as acrylics) have the repeating units of ethylene substituted by alkoxycarbonyl groups: —[CH₂—CH(X)]—, where X can be —CN, —COOH, alkylOC(O)—, or alkylNHC(O)—. The acrylic material can include dispersions of acrylic monomers (including functional acrylic monomers) with a cross-linking catalyst; acrylic copolymers which are capable of self cross-linking; styrene-acrylic copolymers; or functionalized acrylic copolymers.

In some optional implementations, the material used to form the coating 14 can be or includes an acrylic material. In such implementations, the acrylic material can be methyl methacrylate based, butyl acrylate based, ethyl acrylate based, glycidyl methacrylate based, hydroxy-containing acrylate resins, or their mixtures. In such implementations, an polycarbodiimide, an aziridine, or an imidazoline material can serve as an external cross-linking material.

Vinylic Resins

In general, vinyl polymers have the repeating unit of the following formula: —[CH₂—CH(X)]—, where X can be H, alkyl, aryl, or heteroaryl. As an example, the copolymerization of the vinyl monomers such as polyvinyl chloride with ethylene provides varying flexibility and transparency required in many coatings. Polyvinyl chloride has the repeating units of ethylene substituted by chlorine: —[CH₂—CH(X)]—, where X is Cl. Polyethylene has the repeating units of ethylene: —[CH₂—CH₂]—. In some implementations, the material can be or includes an vinyl monomer resin material. In such implementations, the vinylic material can be polyvinyl chloride, polyvinyl chloride-ethylene copolymer, or a thio functionalized vinylic copolymer.

Polyol Resins

In general, a polyol used to form the coating 14 can be a compound containing two or more hydroxyl groups, such as an acrylic polyol, a polyoxyalkylene polyol, a polyester polyol, a polyamide polyol, a polyepoxy polyol, a polyvinyl polyol, a polyalkyd polyol, or a polyurethane polyol. A polyol, in general, can be reacted with the reactive groups such as isocyanates, epoxides and other such reactive groups to produce the coatings.

Acrylic polyols can be typically obtained by polymerization (e.g., by a free-radical mediated) of hydroxyacrylates, optionally in the presence of styrene. Examples of hydroxyacrylates include butanediol monoacrylate (BDMA), 2-hydroxyethyl acrylate (HEA), 2-hydroxypropyl acrylate (HPA), hydroxybutyl acrylate, polycaprolactone modified hydroxyethyl hexylacrylate. In some implementations, the percentage weight of acrylic polyol in the total coating formulation can be from about 5% to about 95%, e.g., from about 5% to about 15%, from about 15% to about 25%, from about 25% to about 35%, from about 35% to about 45%, from about 45% to about 55%, from about 55% to about 65%, from about 65% to about 75%, from about 75% to about 85%, or even from about 85% to about 95%.

A polyoxyalkylene diol is an example of another polyol that can be used to produce the coatings. In some implementations, the polyoxyalkylene diols have a number average molecular weight of from about 200 to about 3,000, e.g., from about 200 to about 1,000, from about 1,000 to about 2,000, or from about 2,000 to about 3,000, as determined using narrow disperse polyethylene glycol standards. Specific examples of polyoxyalkylene diols include polyethyleneether glycol, polypropyleneether glycol, polybutyleneether glycol, polytetramethyleneether glycol, and copolymers thereof. Mixtures of any of the polyoxyalkylene diols can also be used.

Polyesters having terminal hydroxyl groups are another example of a polyol that can be used to produce writeable-erasable coatings as described herein. Such polyester diols can be prepared by the condensation of a diol with a dicarboxylic acid or an equivalent thereof (e.g., acid halide or anhydride). Examples of suitable diols include ethylene glycol, propanediol-1,2, propanediol-1,3, butanediol-1,3, butanediol-1,4, pentanediol-1,2, pentanediol-1,5, hexanediol-1,3, hexanediol-1,6, diethylene glycol, dipropylene glycol, triethylene glycol, tetraethylene glycol, or mixtures of these diols. Examples of suitable acids include oxalic, malonic, succinic, glutaric, adipic, pimelic, suberic, azelaic, terephthalic, sebacic, malic, phthalic, cylohexanedicarboxylic or mixtures of these acids. When preparing these polyester diols, generally an excess of the diol over dicarboxylic acid is used.

In some embodiments, a hydroxyl functional polyester having a hydroxyl number about or more than 100 milligram KOH/g. In some embodiments, a hydroxyl functional polyester having a hydroxyl number about or more than 200 milligram KOH/g. In some embodiments, a hydroxyl functional polyester having a hydroxyl number about or more than 300 milligram KOH/g. In some embodiments, a hydroxyl functional polyester having a hydroxyl number about 100 milligram KOH/g, about 200 milligram KOH/g, about 250 milligram KOH/g, about 260 milligram KOH/g, about 270 milligram KOH/g, about 280 milligram KOH/g, about 290 milligram KOH/g, about 300 milligram KOH/g, about 310 milligram KOH/g, about 320 milligram KOH/g, about 350 milligram KOH/g, about 400 milligram KOH/g, or about 500 milligram KOH/g. In some embodiments, a hydroxyl functional polyester having a hydroxyl number in a range of any two values above. In some embodiments, a saturated hydroxyl functional polyester can be used in accordance with the present invention.

In some embodiments, provided coating materials (e.g., curable compositions such as powder compositions, applied coatings, and/or cured coatings) may comprise about or more than 10 wt % hydroxyl functional polyester. In some embodiments, provided coating materials may comprise about or more than 25 wt % hydroxyl functional polyester. In some embodiments, provided coating materials may comprise about or more than 30 wt % hydroxyl functional polyester. In some embodiments, provided coating materials may comprise about or more than 40 wt % hydroxyl functional polyester. In some embodiments, provided coating materials may comprise about 10 wt %, about 15 wt %, about 20 wt %, about 25 wt %, about 30 wt %, about 35 wt %, about 40 wt %, about 45 wt %, or about 50 wt % hydroxyl functional polyester. In some embodiments, provided coating materials may comprise a hydroxyl functional polyester in a range between a lower value and an upper value. In some embodiments, the lower value is 10%. In some embodiments, the lower value is selected from the group consisting of 10%, 15%, 20%, 25%, 30%, 35%, 40%, 45%, 50%, or more. In some embodiments, the upper value is selected from the group consisting of 60%, 55%, 50%, 45%, 40%, 35%, 30%, 25%, 20%, 15%, 10%, or 5% and the range is any combination of these lower and upper values wherein the upper value is higher than the lower value.

A polyurethane diol, having terminal hydroxyl groups is yet another example of a polyol that can be used to produce the coatings. The polyurethane diols can include polyalkylene, poly(oxyalkylene), polyester, polyamide, polycarbonate, polysulfide, polyacrylate, polymethacrylate, or mixtures of any of these copolymers. In some implementations, the polyurethane diols have a number average molecular weight of from about 200 to 3,000, e.g., from about 200 to about 1,000, from about 1,000 to about 2,000, or from about 2,000 to about 3,000, as determined using narrow disperse polyethylene glycol standards. Polyurethane diols can be advantageously utilized to provide particularly wear and scratch resistant coatings. The polyurethane having terminal hydroxy groups can be prepared by a reaction of any one or more of the polyols discussed above and an organic diisocyanate to provide a isocyanate terminated prepolymer, followed by reaction of the prepolymer with a polyhydric alcohol containing 2-6 hydroxyl groups. Some polyurethane diols are commercially available from Sigma-Aldrich Chemicals or King Industries.

In some implementations, the diol can be reacted with the diisocyanate utilizing a molar ratio of about 1:2, respectively, in the presence of an activator (or accelerator) such as oxazolidine or an organotin compound, e.g., dibutyltin dilaurate or dibutyltin dioctoate. The reaction can be allowed to proceed at a temperature of from about 60° C. to about 180° C. for a period of from about 4 hours to about 24 hours to provide the isocyanate terminated prepolymer.

The isocyanate terminated urethane prepolymer can then be reacted, e.g., from about 60° C. to about 110° C. for about 1 hour to about 10 hours, with a monomeric, polyhydric alcohol containing 2-6 hydroxyl groups in a molar ratio of 1:2, respectively. Examples of monomeric, polyhydric alcohols that can be used include 1,4-cyclohexane dimethanol, 1,4-butanediol, mannitol, trimethylol propane, trimethylol ethane, 1,1-cyclohexane dimethanol, hydrogenated bisphenol A, cyclohexane diol, neopentyl glycol, trimethylpentanediol, pentaerythritol, and trimethylhexanediol. The result of treating the isocyanate terminated urethane prepolymer with the one or more alcohols is a polyurethane diol having 2-10 terminal hydroxy groups and no isocyanates groups.

Polyurethane diols can also be made by reacting organic carbonates with amines. In some implementations in which a polyurethane diol is used to make the coating, the molar proportion of polyurethane diol to the alkoxyalkylamino material can range from about 10:1 to about 1:1, e.g., 5:1 to 1:1.

Examples of commercial polyols include, but are not limited to, polyester resins (available from Cytec) under the trade names CRYLCOAT® (e.g., CRYLCOAT E04174), SAA (a copolymer of styrene-allylic alcohol available from Lyondell Chemical Company) and trimethylolpropane and neopentyl glycol (available from Perstorp).

In some optional implementations, the coating material can be or includes a reaction product of an alkoxyalkylamino material and a polyol. In such implementations, the alkoxyalkylamino material can serve as a cross-linking material.

In other optional implementations, the coating material can be or includes an alkyd material. In such implementations, the alkyd material can be castor oil, soybean oil, sunflower oil, soya oil, linseed oil, tall oil, styrenated vinyl toluene, or their mixtures.

In yet other optional implementations, the coating materials can include rosin phenolic resin, epoxy ester resin, fluorine based resins (such as fluorine modified acrylic, fluorine modified epoxy, fluorine modified alkyd, or fluorine modified polyurethane), silica based resins (such as silica modified acrylic, silica modified epoxy, silica modified alkyd, or silica modified polyurethane).

Hybrid Systems

Some or all of the formulation resins mentioned above may be combined together to form a hybrid system. An hybrid system typically is a admixture of two materials such as, but not limited to, polyester-epoxy hybrid, acrylic-epoxy hybrid, or polyester-urethane hybrid. Hybrid systems can contain two chemical classes which interact cooperatively to provide desired properties. In some implementations, the hybrid material can be a combination of polyurethane/acrylic, epoxy/acrylic, alkyd/acrylic, polyvinyl acetate/acrylic, polyvinyl acetate/epoxy, polyvinyl acetate/polyurethane, or polyvinyl alcohols. In some implementations, a cross-linker can include an polycarbodiimide, an aziridine, or an imidazoline.

Other Modifying Agents in the Formulations

Accelerators are agents that speed up the curing process. Accelerators that can be used in the formulation include dibutyltin dialkanoate (e.g., dibutyltin dialaurate, dibutyltin dioctoate), and oxazolidine. Acid promoters are also typically used to speed up the curing process. Acid promoters include aryl, alkyl, and aralkyl sulfonic acids; aryl, alkyl, and aralkyl phosphoric and phosphonic acids; aryl, alkyl, and aralkyl acid pyrophosphates; carboxylic acids; sulfonimides; mineral acids and mixtures thereof. Examples of sulfonic acids include benzenesulfonic acid, para-toluenesulfonic acid, dodecylbenzenesulfonic acid, and naphthalenesulfonic acid. Examples of aryl, alkyl, and aralkyl phosphates and pyrophosphates include methyl-ethyl, dibenzyl, diphenyl, di-para-tolyl, dimethyl, diethyl, phenyl-para-tolyl, phenyl-benzyl phosphates and pyrophosphates. Examples of carboxylic acids include citric acid, benzoic acid, formic acid, acetic acid, propionic acid, butyric acid, dicarboxylic acids such as oxalic acid, and fluorinated acids such as trifluoroacetic acid. Examples of sulfonimides include dibenzene sulfonimide, di-para-toluene sulfonimide, methyl-para-toluene sulfonimide, and dimethyl sulfonimide. Examples of mineral acids include phosphoric acid, nitric acid, sulfuric acid and hydrochloric acid. In some implementations, a combination of phosphoric acid or citric acid can be utilized as an acid promoter.

Curable and/or cured compositions as described herein can also contain other optional ingredients such as fillers, surfactants, light stabilizers, pigments, opacifying agents, defoaming agent, surface gloss-modifying agent, biocides, viscosity-modifying agent, dispersing agents, reactive diluents, extender pigments, inhibitors for corrosion or efflorescence, flame retardants, intumescent agents, thermal agents for energy efficiency, self-cleaning agents, perfumes, odor sustaining agents, flow control additives, degassing additives, anti-oxidants, UV absorbers, pigment dispersing aids, antistatic additives, charge control additives, tribo charging additives, anti-caking additives, mar resistance additives, slip improving additives, texturizing additives, or matting additives.

Examples of flow control additives include, but are not limited to, acrylate-based polymer (e.g., poly(2-ethylhexyl)acrylate) and amide modified polymeric ester. Exemplary flow control additives are available from TROY under the trade names POWDERMATE® (e.g., Powdermate 570). According to the present invention, provided curable and/or cured compositions may comprise one or more flow control additives. In some embodiments, provided curable and/or cured compositions may comprise about or more than 0.1 wt %, 0.3 wt %, 0.5 wt %, 0.7 wt %, 1 wt %, 1.5 wt %, 2 wt %, or 2.5 wt % flow control additives. In some embodiments, provided curable and/or cured compositions may comprise flow control additives in a range of any two values above.

An example of degassing additives may be benzoin. Exemplary degassing additives are available from TROY under the trade names POWDERMATE® (e.g., Powdermate 542). According to the present invention, provided curable and/or cured compositions may comprise one or more degassing additives. In some embodiments, provided curable and/or cured compositions may comprise about or more than 0.1 wt %, 0.3 wt %, 0.5 wt %, 0.7 wt %, 1 wt %, 1.5 wt %, 2 wt %, or 2.5 wt % degassing additives. In some embodiments, provided curable and/or cured compositions may comprise degassing additives in a range of any two values above.

Curable and/or cured compositions as described herein may further comprise at least one pigment. Examples of suitable pigments include white pigments (e.g., titanium oxide such as KRONOS® 20160 by Kronos, zinc oxide, zirconium oxide, etc.), color pigments (e.g., red iron oxide, yellow iron oxide, black iron oxide, ultramarine blue, Berlin blue, chromium oxide, chromium hydroxide, carbon black, coal tar coloring material, D&C Red Nos. 6, 7, 9, 19, 21, 27, 40, D&C Orange Nos. 4, 5, 10, D&C Yellow Nos. 5, 13, 19, D&C Blue No. 1, natural coloring matter, and the like), and/or pearlescent pigments (e.g., fish scale guanine, mica titanium, bismuth oxychloride, and so forth). In addition or alternatively, processed coloring pigments, such as pigments that have been coated with polymeric materials may be used. Suitable such pigments include SURPASS products from Sun Chemical.

In some embodiments, pigment materials may be particulate. Pigment particles may be combined with or formulated into powder compositions described herein. That is, in some embodiments, provided powder compositions comprise separate particles of resin material (that optionally include one or more additional materials, e.g., homogenously distributed in individual particles) and of pigment (optionally including one or more additional materials); in some embodiments, provided powder compositions comprise particles that contain both resin material and pigment. The median pigment particle size suitable for use in accordance with the present invention may be about 0.01 to 4.0 microns, or about 0.04 to 1.0 microns. Organic pigments typically have a median particle size of less than 0.3 microns. Iron oxide pigments typically have a median particle size of 0.2 to 0.6 microns. Carbon black has a median particle size around 0.07 microns, while phthalocyanine blue typically has a median particle size around 0.05 microns.

In some embodiments, provided curable and/or cured compositions may comprise about or more than 10 wt % pigment. In some embodiments, provided curable and/or cured compositions may comprise about or more than 20 wt % pigment. In some embodiments, provided curable and/or cured compositions may comprise about or more than 30 wt % pigment. In some embodiments, provided curable and/or cured compositions may comprise about or more than 35 wt % pigment. In some embodiments, provided curable and/or cured compositions may comprise about 0 wt %, about 5 wt %, about 10 wt %, about 15 wt %, about 20 wt %, about 25 wt %, about 30 wt %, about 35 wt %, or about 40 wt % pigment. In some embodiments, the percentage weight of pigments in the provided curable and/or cured compositions is in a range between a lower value and an upper value. In some embodiments, the lower value is about 0%. In some embodiments, the lower value is selected from the group consisting of 0%, 5%, 10%, 15%, 20%, 25%, 30%, 35%, 40% or more. In some embodiments, the upper value is selected from the group consisting of 60%, 50%, 40%, 35%, 30%, 25%, 20%, 15%, 10%, 5%, and the range is any combination of these lower and upper values wherein the upper value is higher than the lower value.

Several commercial suitable light stabilizers are available from CIBA Specialty Chemicals under the trade names TINUVIN® (benzotriazole, triazine, or hindered amine based) and CHIMASSORB® (benzophenone based). Examples of opacifying agents zinc oxide, titanium dioxide, silicon dioxide, Kaolin clay, e.g., high whiteness Kaolin clay, or mixtures thereof. Examples of defoaming agents include polyethylene glycols, or silicone surfactants, e.g., polyether modified polydimethyl siloxane. Defoaming agents such as the BYK family of agents are available from BYK-Chemie GmbH. Examples of viscosity modifying agents include polyurethanes, or a commercial acrylic copolymer, TAFIGEL®, available from Munzing Chemie GmbH.

### Methods for Production of Powder for Coating:

The powder formulations which contain the mixture of resins, optionally along with cross-linkers, curing agents, pigments, and other modifying agents described above can be produced by any suitable conventional methods known to one skilled in the art. The various raw materials (such as resins, additives) that could be used to prepare the coating 14, and the methods of production of the coatings 14 include those described herein and those known in the art, such as those described in Lange, Powder coatings chemistry and technology, 2^{nd} edition, Vincentz Network (2004) along with information publicly available at http://www.powdercoatings.org (accessed May 4, 2009). Typically, the resin, cross-linkers, curing agents, pigments, and other modifying agents can be pre-mixed, preferably multiple times, followed by extruding (such as in a twin screw extruder) which can then be fed into a grinding machine (such as a hammer mill or a pin disc mill). The granules can then be sieved to obtain a uniform desired particle size. Such particles can then be packaged into suitable containers for later use in forming a powder coating.

### Methods for Application of Powder for Coating:

Powder coating compositions are typically applied by spraying. In some embodiments, the materials that form the coating 14, prior to the application on substrates, can be in a powdered form. The material in the powder form can be applied to a substrate by a process such as spraying using a fluidized bed technique, electrostatic spraying, or flame-spraying. The electrostatic spraying can be performed with a corona gun which can impart a positive charge to the powder being sprayed or with a tribo gun which can impart charge through mechanical friction. In some applications where the tribo gun is used, the formulations can include tribo-charging additives such as TINUVIN 144 or ELTRIBO. Other methods of applying a material in a powder form, such as flocking, can also be employed if certain properties (e.g., coating thickness) are desired.

Certain implementations are further described in the following examples, which are not intended to limit the scope of the disclosure.

### EXAMPLES

### Example 1

### Quantitative Determination of The Erasable Characteristics of The Writable-Erasable Surface

The color stimulus, which is the radiation from the colored object that produces the perception of that color, can be measured. Color perception is affected not only by the spectral make up of the object, but also the light source under which it is viewed. If the spectral distribution of the light source and the relative spectral reflectance of the object are known, then the spectral composition reaching the eye of an observer with normal vision from the object illuminated by that source can be calculated. The Commission Internationale de L′Eclairage (CIE) has set up procedures for calculation of the color differences in a CIELAB color space. The formulation types described can be coated over a test panel. The red, blue and green Expo 1 markers can be used. The Quartet Ghost Duster® eraser can be used. The X-Rite Sp-62 Spectrophotometer can be used to take the color readings and it calculates these values automatically. The values can then be recorded. The changes can be calculated according to ASTM Test Method D2244, as differences in the L*, a*, and b* values, where the direction of the color difference is described by the magnitude and the algebraic signs of the components, −L*, −a*, −b*. The values can then be calculated as follows:

−L*=L*₁−L*₀ (1)

−a*=a*₁−a*₀ (2)

−b*=b*₁−b*₀ (3)

where L*₀, a*₀, b*₀ refers to the reference, and L*₁, a*₁, b*₁, refers to the test specimen. Table 1 shows the magnitude and direction of each color value and what color change occurs.

TABLE 1
Meanings of Color Values

| Direction | Color Change Value | Result |
|---|---|---|
| + | L* | Lighter |
| − | L* | Darker |
| + | A* | Redder (less green) |
| − | A* | Green (less red) |
| + | B* | Yellow (less blue) |
| − | B* | Bluer (less yellow) |

By choosing one sample to be the reference point, the change in color from this reference point is called the color difference (ΔE), which is calculated from the equation:

ΔE=[(−L*)²+(−a*)²+(−b*)²]^{1/2} (4)

The measured color difference (ΔE) after certain number of cycles of writing and erasing, for the writable-erasable surface 16 of the cured coating obtained from the formulation described in Example 1, can be tabulated to determine the erasable characteristics of the writable-erasable surface.

### Example 2

### Determination of Erasable Characteristics of a Writable-Erasable Surface

The nature of visual change (erasable characteristics) on the writable-erasable surface 16 can be evaluated by the visual change perceived after the surface has been marked followed by erasing the marking. It can be characterized by the leave behind which can be determined after 1 or 2 passes by the eraser to erase the marking: the markings may seem to stick to the surface and they might erase as in streaks or might be spotty. The quality of the surface can also be measured by the dirtiness which can be determined after one pass with the eraser over the marked area, a faint to dark cloud might be left from the eraser, like smearing of the marking due to the eraser. Both “leave behind” and “dirtiness” can be measured on a scale of zero to ten based on the degree to which the marking material can be removed from the surface. The lower number indicates a better surface performance.

### Example 3

### Powder Compositions

Various components (e.g., resins, additives) can be mixed and extruded to make particles, which can then be packaged into suitable containers for later use in forming a powder coating.

For example, the components described in the Table 2 and Table 3 were mixed, following a procedure similar to commonly used methods as described above, to obtain polyurethane resin based compositions containing the components having the exemplary weight percentage indicated in the table.

TABLE 2
Powder composition described in Sample 1

| Component | wt % |
|---|---|
| Hydroxyl Polyester (e.g., | 29.2 |
| Crylcoat E04174) | |
| Blocked Isocyanate (e.g., | 44.1 |
| Alcure 4402) | |
| Flow Agent (e.g., | 1.0 |
| Powdermate 570) | |
| Degassing Agent (e.g., | 0.7 |
| Benzoin) | |
| Titanium Dioxide (e.g., | 25.0 |
| Kronos 2160) | |
| Total | 100.0 |

TABLE 3
Powder composition described in Sample 2

| Component | wt % |
|---|---|
| Hydroxyl Polyester (e.g., | 38.3 |
| Crylcoat E04174) | |
| Blocked Isocyanate (e.g., | 60.0 |
| Alcure 4402) | |
| Flow Agent (e.g., | 1.0 |
| Powdermate 570) | |
| Degassing Agent (e.g, | 0.7 |
| Powdermate 542) | |
| Total | 100.0 |

The range of weight percentage (wt %) on the total weight of exemplary powder compositions in accordance with the present invention are listed in the Tables 4-6 below.

TABLE 4
An exemplary powder composition

| | Rang of wt % on |
|---|---|
| Component | total weight |
| Hydroxyl Polyester | 25-35 |
| Blocked Isocyanate | 40-50 |
| Flow Agent | 0.8-1.2 |
| Degassing Agent | 0.6-0.8 |
| Pigment | 20-30 |

TABLE 5
An exemplary powder composition

| | Rang of wt % on |
|---|---|
| Component | total weight |
| Hydroxyl Polyester | 35-40 |
| Blocked Isocyanate | 55-65 |
| Flow Agent | 0.8-1.2 |
| Degassing Agent | 0.6-0.8 |
| Pigment | 0-10 |

TABLE 6
An exemplary powder composition

| | Rang of wt % on |
|---|---|
| Component | total weight |
| Hydroxyl Polyester | 25-40 |
| Blocked Isocyanate | 30-70 |
| Flow Agent | 0.5-1.5 |
| Degassing Agent | 0.5-1.0 |
| Pigment | 0-35 |

### OTHER IMPLEMENTATIONS

A number of implementations have been described. Nevertheless, it will be understood that various modifications can be made without departing from the spirit and scope of the disclosure. Accordingly, other implementations are within the scope of the following claims.

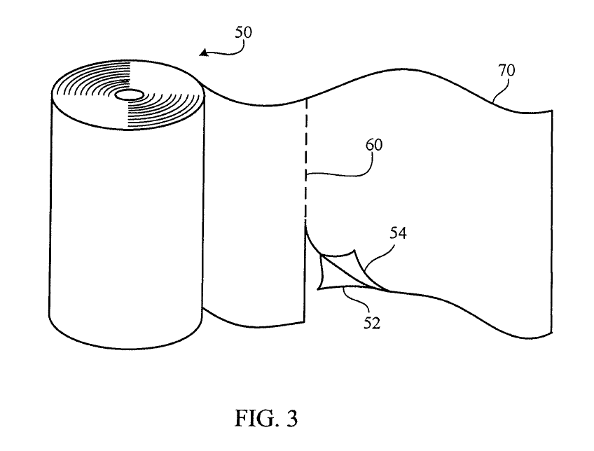

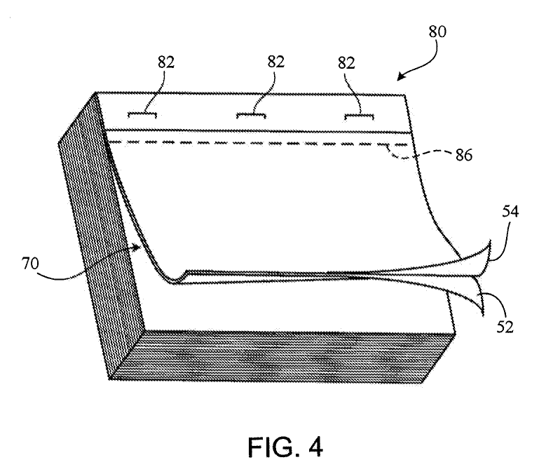

While fiberboards and metals have been described, the coatings can be applied to other forms. For example, referring now to FIG. 3, any of the materials described herein can be applied to a continuous sheet of material, such as paper, to provide a product 50 that includes a substrate 52 and a coating 54 extending upon. As shown in FIG. 3, the product 50 can be conveniently stored in a roll form. If desired, product 50 can be cut, e.g., along a transverse line 60, to provide individual sheets 70 of material. Referring now to FIG. 4, sheets 70 can be fashioned into a product 80 in tablet form using fasteners 82. If desired, the assembled sheets can have perforations 86, allowing sheets to be torn from the tablet and used as a mobile writable-erasable product.

The components of the formulation can be applied to the substrate, e.g., by concurrently spraying the components so that they mix in flight and/or on the substrate, and then optionally applying a cross-linking promoter, such as an acid. In still other implementations, a cross-linking promoter is first applied to the substrate, and then the components are applied to the substrate having the cross-linking promoter.

Still other implementations are within the scope of the following claims.

What is claimed is:

1. A powder composition comprising:
between about 30 wt % to about 70 wt % isocyanate material; and
between about 10 wt % to about 45 wt % polyol material;
wherein the powder composition cures to form a writable-erasable coating when applied to a substrate.

2. The powder composition of claim 1, wherein the isocyanate material is or comprises an isocyanate, a blocked isocyanate, oligomers and homopolymers thereof or any combination thereof.

3. The powder composition of claim 2, wherein the blocked isocyanate is or comprises an aliphatic blocked isocyanate.

4. The powder composition of claim 2, wherein the blocked isocyanate has an isocyanate equivalent weight of about 280 grams.

5. The powder composition of claim 1, wherein the polyol material is or comprises a hydroxyl polyester.

6. The powder composition of claim 5, wherein the hydroxyl polyester is or comprises a saturated hydroxyl polyester.

7. The powder composition of claim 5, wherein the hydroxyl polyester has a hydroxyl number about 290 milligrams KOH/g.

8. The powder composition of claim 1, further comprising a curing agent, a pigment, or an additive.

9. The powder composition of claim 8, wherein the weight percentage of the pigment in the powder composition is in a range of 0 wt % to 40 wt %.

10. The powder composition of claim 8, wherein the additive is or comprises a flow control additive.

11. The powder composition of claim 8, wherein the additive is or comprises a degassing additive.

12. The powder composition of claim 1, wherein the powder composition has a glass transition temperature of greater than about 40° C.

13. The powder composition of claim 1, wherein the powder composition has an average particle size of from 2 microns to about 100 microns.

14. A writable-erasable product comprising:
a cured coating extending upon a substrate and having a writable-erasable surface; the coating being curable from a powder composition, upon exposure to an elevated temperature, a radiation or a combination thereof;
wherein, after the writable-erasable surface is marked with a marking material comprising a colorant and a solvent, the marking material can be erased from the writable-erasable surface to be effectively invisible.

15. The writable-erasable product of claim 14, wherein the marking material can be erased from the writable-erasable surface to be substantially invisible.

16. The writable-erasable product of claim 14, wherein the cured coating is cross-linked.

17. The writable-erasable product of claim 14, wherein the elevated temperature is from about 40° C. to about 200° C.

18. The writable-erasable product of claim 14, wherein the radiation is selected from the group consisting of ultra-violet, electron-beam, infrared, mid infrared, near infrared and a combination thereof.

19. The writable-erasable product of claim 14, wherein the cured coating has a porosity of less than about 40 percent.

20. The writable-erasable product of claim 14, wherein the cured coating has a thickness of from about 0.001 inch to about 0.125 inch.

21. The writable-erasable product of claim 14, wherein the cured coating has a Taber abrasion value of from about 100 to about 125 mg/thousand cycles.

22. The writable-erasable product of claim 14, wherein the cured coating has a Sward hardness of greater than about 10.

23. The writable-erasable product of claim 14, wherein the cured coating has an elongation at break of between about 5 percent and about 400 percent.

24. The writable-erasable product of claim 14, wherein the writable-erasable surface has an average surface roughness (Rₐ) of less than about 7,500 nm.

25. The writable-erasable product of claim 14, wherein the writable-erasable surface has a maximum surface roughness (Rₘ) of less than about 10,000 nm.

26. The writable-erasable product of claim 14, wherein the writable-erasable surface has a contact angle of greater than about 35 degrees.

27. The writable-erasable product of claim 14, wherein the writable-erasable surface has a contact angle of less than about 150 degrees.

28. The writable-erasable product of claim 14, wherein the powder composition comprises a resin.

29. The writable-erasable product of claim 28, wherein the resin is selected from the group consisting of polyurethane resins, epoxy resins, polyester resins, polyamide resins, alkyd resins, polyvinyl resins, polyolefin resins, acrylic resins, and mixtures thereof.

30. The writable-erasable product of claim 28, wherein the powder composition further comprises a curing agent, a pigment, or an additive.

31-43. (canceled)

44. A method of changeably presenting information, the method comprising:
a) marking the writable-erasable surface of claim 14 with a first information using a marking material comprising a colorant and a solvent;
b) erasing the marking of the first information from the writable-erasable surface to be effectively invisible;
c) marking the writable-erasable surface with a second information; and
d) erasing the marking of the second information from the writable-erasable surface to be effectively invisible.

45-50. (canceled)

51. A method of making a writable-erasable product, the method comprising:
applying a powder composition to a substrate to form a coating extending upon the substrate; and
exposing the coating to an elevated temperature or radiation to provide a cured coating defining a writable-erasable surface;
wherein, after the writable-erasable surface is marked with a marking material comprising a colorant and a solvent, the marking material can be erased from the writable-erasable surface to be effectively invisible.

52-56. (canceled)
